(19) United States
(12) Patent Application Publication
(10) Pub. No.: US 2025/0300222 A1
(43) Pub. Date: Sep. 25, 2025

(54) PROCESS FOR RAPID PARTICLE GROWTH OF SOLID ELECTROLYTE MATERIAL

(71) Applicant: Solid Power Operating, Inc., Louisville, CO (US)

(72) Inventors: Brian E. FRANCISCO, Arvada, CO (US); Samuel M. OBERWETTER, Lafayette, CO (US)

(21) Appl. No.: 19/088,807

(22) Filed: Mar. 24, 2025

Related U.S. Application Data
(60) Provisional application No. 63/568,704, filed on Mar. 22, 2024.

(51) Int. Cl. H01M 10/0562; H01M 10/052

(52) U.S. Cl. CPC H01M 10/0562; H01M 10/052; H01M 2300/008

(57) ABSTRACT

Methods for increasing the particle size of solid electrolyte materials include combining the solid electrolyte material with molten elemental sulfur. By combining the solid electrolyte material with molten elemental sulfur, the particle size of the solid electrolyte material increases and the specific surface area of the solid electrolyte material decreases.

### CROSS-REFERENCE TO RELATED APPLICATION

This application is related to and claims priority under 35 U.S.C. § 119 (e) to U.S. Patent Application No. 63/568,704, filed Mar. 22, 2024, titled “PROCESS FOR RAPID PARTICLE GROWTH OF SOLID ELECTROLYTE MATERIAL,” the entire contents of which are incorporated herein by reference for all purposes.

### FIELD OF THE DISCLOSURE

The present disclosure is related to methods for making solid electrolyte materials.

### BACKGROUND

Over the years, the need for safer, more powerful batteries has grown. To meet these needs, the flammable and leak prone liquid electrolyte used in Li-Ion batteries may be replaced with a solid-state electrolyte material, among other changes to the battery cell. Types of solid-state electrolyte materials that have garnered the attention of battery manufacturers are sulfide-based solid electrolytes. In some arrangements, to build a functioning solid-state battery, the solid electrolyte material may be integrated into the negative or positive electrodes of the battery. When forming the negative or positive electrodes, maximizing physical contact between the electrolyte particles and the particles of the active materials in the electrodes is often paramount.

Of the many techniques used to maximize this physical contact, tailoring the particle size of the solid electrolyte material used has proven to be very effective. Unfortunately, there are only established techniques to reduce the particle size of these materials and no reliable way to increase the size of the particles. These and other problems may be solved, alone or in combination, by various aspects of the present disclosure.

### Summary of Disclosure

Provided herein are processes for growing the particle size of a solid electrolyte including lithium and sulfur. The processes include combining the solid electrolyte with molten elemental sulfur at a temperature greater than 100° C. for a period of time greater than 1 minute; and separating the solid electrolyte from the molten elemental sulfur. In some embodiments, combining the solid electrolyte with the molten elemental sulfur takes place at a temperature from about 115° C. to about 500° C. In some embodiments, at least 90% of the molten elemental sulfur is separated from the solid electrolyte by way of filtering, centrifuging, evaporating or combination thereof. In some embodiments combining the solid electrolyte with the molten elemental sulfur takes place for a period of time from about 15 minutes to about 36 hours. In some embodiments, the weight ratio between the molten elemental sulfur and the solid electrolyte is from about 1:99 to about 99:1, or from about 1:9 to about 9:1. In some embodiments, the combining may be performed in a closed vessel, an open vessel, or a semi-closed (i.e., partially closed) vessel. In some embodiments, the average particle size of the solid electrolyte increases by greater than 10% as a result of the combining.

Further provided herein are solid electrolytes produced by the processes described herein. In some embodiments, the solid electrolyte has a particle size distribution (PSD) with a D50 of greater than about 30 μm. In some embodiments, the solid electrolyte has a specific surface area from about 0.1 m²/g to about 5 m²/g. In some embodiments, the solid electrolyte has an amorphous structure. In some embodiments, the solid electrolyte has a crystalline structure. In some embodiments, the solid electrolyte has an Argyrodite structure. In some embodiments, the solid electrolyte has an X-ray diffraction pattern with peaks corresponding to a 2theta of 17.5°±0.5°, 18.1°±0.5°, 19.9°±0.5°, 22.8°±0.5°, 25.95°±0.5°, 29.1°±0.5°, 29.9°±0.5°, and 31.1°±0.5° with Cu-Kα(1,2)=1.541 Å. In some embodiments, the solid electrolyte has the formula Li_{(7-y-z)}PS_{(6-y-z)}X_{y}W_{z}, wherein X and W are individually selected from F, Cl, Br, and I; 0≤y≤2; 0≤z≤2; and wherein 0≤y+z≤2. In some embodiments, the solid electrolyte includes Li₃PS₄, Li₄P₂S₆, Li₇P₃S₁₁, Li_{5.5}PS_{4.5}Cl_{1.5}, Li_{5.5}PS_{4.5}ClBr_{0.5}, Li₅PS₄Cl₂, Li₅PS₄ClBr, or any combination thereof.

Further provided herein are solid-state batteries comprising the solid electrolytes produced by the processes described herein. The batteries include an anode layer, a cathode layer, and a separator layer, wherein one or more of the anode layer, the separator layer, and the cathode layer includes a solid electrolyte produced by the processes described herein. In some embodiments, the solid electrolyte has a specific surface area from about 0.1 m²/g to about 5 m²/g.

### BRIEF DESCRIPTION OF THE FIGURES

FIG. 1 shows a chart depicting the D50 particle size distribution (PSD) of the sulfide-based solid electrolyte produced in Example 1, Example 2, Example 3, and Example 4.

FIG. 2 shows a chart depicting the specific surface area (SSA) of the sulfide-based solid electrolyte produced in Example 1, Example 2, Example 3, and Example 4.

FIG. 3 shows an X-ray diffraction pattern of the solid electrolytes prepared in Example 1 and Example 4.

### DETAILED DESCRIPTION

Before aspects of the present invention are disclosed and described, it is to be understood that this invention is not limited to the particular methods, compositions, or materials disclosed herein, but is extended to equivalents thereof as would be recognized by those ordinarily skilled in the relevant arts. It should also be understood that terminology employed herein is used for the purpose of describing particular embodiments only and is not intended to be limiting.

Concentrations, amounts, and other numerical data may be expressed or presented herein in a range format. It is to be understood that such a range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 2 to about 50” should be interpreted to include not only the explicitly recited values of 2 to 50, but also include all individual values and sub-ranges within the indicated range. Thus, included in this numerical range are individual values such as 2, 2.4, 3, 3.7, 4, 5.5, 10, 10.1, 14, 15, 15.98, 20, 20.13, 23, 25.06, 30, 35.1, 38.0, 40, 44, 44.6, 45, 48, and sub-ranges such as from 1-3, from 2-4, from 5-10, from 5-20, from 5-25, from 5-30, from 5-35, from 5-40, from 5-50, from 2-10, from 2-20, from 2-30, from 2-40, from 2-50, etc. This same principle applies to ranges reciting only one numerical value as a minimum or a maximum. Furthermore, such an interpretation should apply regardless of the breadth of the range or the characteristics being described.

As used herein, the term “about” is used to provide flexibility to a numerical range endpoint by providing that a given value may be “a little above” or “a little below” the endpoint. For example, the endpoint may be within 10%, 8%, 5%, 3%, 2%, or 1% of the listed value. Further, for the sake of convenience and brevity, a numerical range of “about 50 mg/mL to about 80 mg/mL” should also be understood to provide support for the range of “50 mg/mL to 80 mg/mL.” The endpoint may also be based on the variability allowed by an appropriate regulatory body, such as the FDA, USP, etc.

In this disclosure, the terms “including,” “containing,” and/or “having” are understood to mean comprising, and are open ended terms.

As used herein, the term “electrolyte” refers to a complete material suitable for use as the electrolyte in an electrochemical device. A “solid electrolyte” refers to an electrolyte in the solid state, which is suitable for use in the same state. The solid electrolyte or electrolyte may be a pure, i.e., a single component material, with respect to both chemical composition, crystalline structure, and atomic structure, or it may contain a mixture of components having different chemical compositions, crystalline structures, and/or atomic structures.

As used herein, the term “composite” refers to a mixture of at least two components having distinct chemical compositions, crystalline structures, and/or atomic structures.

As used herein, the term “compound” refers to a component defined by a single chemical composition and a single crystalline structure.

As used herein, the term “elemental sulfur” refers to atomic sulfur as well as known sulfur allotropes, including but not limited to S₈, S₇, S₆, and polymorphs thereof.

Described herein are processes for growing the particle size of sulfide-based solid electrolytes. The processes generally include combining sulfide-based solid electrolytes with elemental sulfur in a molten state and separating the sulfide-based solid electrolyte. As a result of the process, the particle size of the sulfide-based solid electrolyte may be rapidly increased. The combining occurs in a vessel suitable for containing the sulfide-based solid electrolytes and elemental sulfur at high temperatures. The process may be performed using low temperatures and widely available materials.

Combining the at sulfide-based solid electrolyte with molten elemental sulfur may be accomplished by mixing the sulfide-based solid electrolyte and the molten elemental sulfur using agitation, grinding, milling, or high energy shearing.

For the elemental sulfur to be in a molten state, the elemental sulfur may be heated to a temperature of greater than 100° C., such as from about 100° C. to about 500° C., during the contacting. For example, the elemental sulfur may be heated to a temperature from about 100° C. to about 200° C., about 100° C. to about 300° C., about 100° C. to about 400° C., about 100° C. to about 500° C., about 200° C. to about 300° C., about 200° C. to about 400° C., about 200° C. to about 500° C., about 300° C. to about 400° C., about 300° C. to about 500° C., or about 400° C. to about 500° C. As another example, the elemental sulfur may be heated to a temperature of about 100° C., 125° C., 150° C., 175° C., 200° C., 225° C., 250° C., 275° C., 300° C., 325° C., 350° C., 375° C., 400° C., 425° C., 450° C., 475° C., or about 500° C. In one embodiment, the temperature may be from about 115° C. to about 500° C. In one embodiment, heating the sulfur to a temperature from about 115° C. to about 250° C. may provide optimal particle growth conditions, as the sulfur has a low vapor pressure at these conditions, thereby minimizing the rate of evaporation. In another embodiment, heating the sulfur to a temperature from 250° C. to 400° C. at elevated pressure may produce an optimal environment for electrolyte particle growth.

When using temperatures above the melting point of the elemental sulfur, some sulfur may be in a vapor phase in addition to the liquid phase. To prevent sulfur from leaving the system, a closed vessel may be used during the contacting. The vessel may be pressurized. Alternatively, the vessel may be only partially closed to allow for a buildup of pressure while simultaneously allowing a small amount of sulfur vapor and other gases to leave the vessel.

The elemental sulfur may be heated to a molten state before adding the sulfide-based solid electrolyte. Alternatively, the sulfide-based solid electrolyte and elemental sulfur may be combined first then the mixture may be heated to the point where the sulfur transitions into a molten state.

The elemental sulfur and the sulfide-based solid electrolyte may be present in the mixture in a volumetric ratio from about 1:99 to about 99:1. For example, the volumetric ratio of elemental sulfur to the sulfide-based solid electrolyte may be from about 1:99 to about 1:75, about 1:99 to about 1:50, about 1:99 to about 1:25, about 1:99 to about 1:10, about 1:99 to about 1:5, about 1:99 to about 1:1, about 1:99 to about 5:1, about 1:99 to about 10:1, about 1:99 to about 25:1, about 1:99 to about 50:1, about 1:99 to about 75:1, about 1:99 to about 99:1, about 1:75 to about 99:1, about 1:50 to about 99:1, about 1:25 to about 99:1, about 1:10 to about 99:1, about 1:5 to about 99:1, about 1:1 to about 99:1, about 5:1 to about 99:1, about 10:1 to about 99:1, about 25:1 to about 99:1, about 50:1 to about 99:1, about 75:1 to about 99:1, about 1:75 to about 75:1, about 1:50 to about 50:1, about 1:25 to about 25:1, about 1:10 to about 10:1, or about 1:5 to about 5:1. As another example, the volumetric ratio of elemental sulfur to the sulfide-based solid electrolyte may be about 1:99, 1:90, 1:80, 1:70, 1:60, 1:50, 1:40, 1:30, 1:20, 1:10, 1:9, 1:8, 1:7, 1:6, 1:5, 1:4, 1:3, 1:2, 1:1, 2:1, 3:1, 4:1, 5:1, 6:1, 7:1, 8:1, 9:1, 10:1, 20:1, 30:1, 40:1, 50:1, 60:1, 70:1, 80:1, 90:1, or about 99:1.

The elemental sulfur and the sulfide-based solid electrolyte may be present in the mixture in a weight ratio from about 1:99 to about 99:1. For example, the weight ratio of elemental sulfur to the sulfide-based solid electrolyte may be from about 1:99 to about 1:75, about 1:99 to about 1:50, about 1:99 to about 1:25, about 1:99 to about 1:10, about 1:99 to about 1:5, about 1:99 to about 1:1, about 1:99 to about 5:1, about 1:99 to about 10:1, about 1:99 to about 25:1, about 1:99 to about 50:1, about 1:99 to about 75:1, about 1:99 to about 99:1, about 1:75 to about 99:1, about 1:50 to about 99:1, about 1:25 to about 99:1, about 1:10 to about 99:1, about 1:5 to about 99:1, about 1:1 to about 99:1, about 5:1 to about 99:1, about 10:1 to about 99:1, about 25:1 to about 99:1, about 50:1 to about 99:1, about 75:1 to about 99:1, about 1:75 to about 75:1, about 1:50 to about 50:1, about 1:25 to about 25:1, about 1:10 to about 10:1, or about 1:5 to about 5:1. As another example, the weight ratio of elemental sulfur to the sulfide-based solid electrolyte may be about 1:99, 1:90, 1:80, 1:70, 1:60, 1:50, 1:40, 1:30, 1:20, 1:10, 1:9, 1:8, 1:7, 1:6, 1:5, 1:4, 1:3, 1:2, 1:1, 2:1, 3:1, 4:1, 5:1, 6:1, 7:1, 8:1, 9:1, 10:1, 20:1, 30:1, 40:1, 50:1, 60:1, 70:1, 80:1, 90:1, or about 99:1.

The sulfide-based solid electrolyte may be combined with the molten elemental sulfur for a period of time long enough for the electrolyte particles to grow to the desired size. Nonlimiting examples of this duration of time may be greater than 1 minute, greater than 10 minutes, greater than 20 minutes, greater than 30 minutes, greater than 45 minutes, greater than 1 hour, greater than 2 hours, greater than 4 hours, greater than 8 hours, or greater than 12 hours. In some embodiments, the sulfide-based solid electrolyte may be combined the molten elemental sulfur for a period of time from about 15 minutes to about 36 hours, such as about 15 minutes to about 30 minutes, about 15 minutes to about 1 hour, about 15 minutes to about 2 hours, about 15 minutes to about 4 hours, about 15 minutes to about 8 hours, about 15 minutes to about 12 hours, about 15 minutes to about 24 hours, about 15 minutes to about 36 hours, about 30 minutes to about 36 hours, about 1 hour to about 36 hours, about 2 hours to about 36 hours, about 4 hours to about 36 hours, about 8 hours to about 36 hours, about 12 hours to about 36 hours, or about 24 hours to about 36 hours.

During this time, the electrolyte particles are sintered such that the electrolyte particles fuse together, thereby increasing the particle size of the sulfide-based solid electrolyte, and consequently decreasing the total surface area of the sulfide-based solid electrolyte.

The process may increase the average particle size of the sulfide-based solid electrolyte (D50) by about 10% or greater. For example, the process may increase the average particle size (D50) of the sulfide-based solid electrolyte by about 10% or greater, about 20% or greater, about 30% or greater, about 40% or greater, or about 50% or greater.

The process may decrease the surface area of the sulfide-based solid electrolyte by about 10% or greater. For example, the process may decrease the surface area of the sulfide-based solid electrolyte by about 10% or greater, about 20% or greater, about 30% or greater, about 40% or greater, or about 50% or greater.

The process then proceeds by separating the sulfide-based solid electrolyte from the elemental sulfur. The sulfide-based solid electrolyte may be separated from the elemental sulfur by filtering the mixture, centrifuging the mixture, evaporating the mixture, or a combination thereof. Preferably, the elemental sulfur is removed from the mixture via evaporation.

The resulting sulfide-based solid electrolyte may have a particle size distribution (PSD) with a D50 of greater than about 30 μm. For example, the resulting sulfide-based solid electrolyte may have a PSD with a D50 of about 30 μm or greater, about 35 μm or greater, about 40 μm or greater, about 45 μm or greater, about 50 μm or greater, about 55 μm or greater, about 60 μm or greater, about 65 μm or greater, or about 70 μm or greater. As another example, the resulting sulfide-based solid electrolyte may have a PSD with a D50 from about 30 μm to about 40 μm, about 30 μm to about 50 μm, about 30 μm to about 60 μm, about 30 μm to about 70 μm, about 40 μm to about 50 μm, about 40 μm to about 60 μm, about 40 μm to about 70 μm, about 50 μm to about 60 μm, about 50 μm to about 70 μm, or about 60 μm to about 70 μm. As another example, the resulting sulfide-based solid electrolyte may have a PSD with a D50 of about 30 μm, 31 μm, 32 μm, 33 μm, 34 μm, 35 μm, 36 μm, 37 μm, 38 μm, 39 μm, 40 μm, 41 μm, 42 μm, 43 μm, 44 μm, 45 μm, 46 μm, 47 μm, 48 μm, 49 μm, 50 μm, 51 μm, 52 μm, 53 μm, 54 μm, 55 μm, 56 μm, 57 μm, 58 μm, 59 μm, 60 μm, 61 μm, 62 μm, 63 μm, 64 μm, 65 μm, 66 μm, 67 μm, 68 μm, 69 μm, or about 70 μm. In an example, the resulting sulfide-based solid electrolyte may have a PSD with a D50 of 50 μm or greater.

In some embodiments, the resulting sulfide-based solid electrolyte may have a PSD with a D50 from about 1 μm to about 2000 μm. For example, the resulting sulfide-based solid electrolyte may have a PSD with a D50 from about 1 μm to about 10 μm, about 1 μm to about 50 μm, about 1 μm to about 100 μm, about 1 μm to about 500 μm, about 1 μm to about 1000 μm, about 1 μm to about 1500 μm, about 1 μm to about 2000 μm, about 10 μm to about 2000 μm, about 50 μm to about 2000 μm, about 100 μm to about 2000 μm, about 500 μm to about 2000 μm, about 1000 μm to about 2000 μm, about 1500 μm to about 2000 μm, about 100 μm to about 1000 μm, about 500 μm to about 1000 μm, about 100 μm to about 500 μm, or about 500 μm to about 1500 μm. As another example, the resulting sulfide-based solid electrolyte may have a PSD with a D50 of about 1 μm, 2 μm, 3 μm, 4 μm, 5 μm, 6 μm, 7 μm, 8 μm, 9 μm, 10 μm, 20 μm, 30 μm, 40 μm, 50 μm, 60 μm, 70 μm, 80 μm, 90 μm, 100 μm, 200 μm, 300 μm, 400 μm, 500 μm, 600 μm, 700 μm, 800 μm, 900 μm, 1000 μm, 1100 μm, 1200 μm, 1300 μm, 1400 μm, 1500 μm, 1700 μm, 1800 μm, 1900 μm, or about 2000 μm.

The resulting sulfide-based solid electrolyte may have a surface area of about 5 m²/g or less. For example, the resulting sulfide-based solid electrolyte may have a surface area of about 5 m²/g or less, about 4 m²/g or less, about 3 m²/g or less, about 2 m²/g or less, about 1 m²/g or less, or about 0.5 m²/g or less. As another example, the resulting sulfide-based solid electrolyte may have a surface area from about 0.5 m²/g to about 1 m²/g, about 0.5 m²/g to about 2 m²/g, about 0.5 m²/g to about 3 m²/g, about 0.5 m²/g to about 4 m²/g, about 0.5 m²/g to about 5 m²/g, about 1 m²/g to about 2 m²/g, about 1 m²/g to about 3 m²/g, about 1 m²/g to about 4 m²/g, about 1 m²/g to about 5 m²/g, about 2 m²/g to about 3 m²/g, about 2 m²/g to about 4 m²/g, about 2 m²/g to about 5 m²/g, about 3 m²/g to about 4 m²/g, about 3 m²/g to about 5 m²/g, or about 4 m²/g to about 5 m²/g. As another example, the resulting sulfide-based solid electrolyte may have a surface area of about 0.5 m²/g, 0.6 m²/g, 0.7 m²/g, 0.8 m²/g, 0.9 m²/g, 1 m²/g, 1.25 m²/g, 1.5 m²/g, 1.75 m²/g, 2 m²/g, 2.25 m²/g, 2.5 m²/g, 2.75 m²/g, 3 m²/g, 3.25 m²/g, 3.5 m²/g, 3.75 m²/g, 4 m²/g, 4.25 m²/g, 4.5 m²/g, 4.75 m²/g, or about 5 m²/g. In an example, the surface area of the resulting sulfide-based solid electrolyte may be less than 2 m²/g.

The sulfide-based solid electrolyte may have a crystalline structure. In some embodiments, the sulfide-based solid electrolyte may have an X-ray diffraction pattern with peaks corresponding to a 2theta of 17.5°±0.5°, 18.1°±0.5°, 19.9°±0.5°, 22.8°±0.5°, 25.95°±0.5°, 29.1°±0.5°, 29.9°±0.5°, and 31.1°±0.5° with Cu-Kα(1,2)=1.541 Å. In another example, the sulfide-based solid electrolyte material may have an amorphous structure, or a combination of crystalline and amorphous.

The process may further include preparing the sulfide-based solid electrolyte. The sulfide-based solid electrolyte may be prepared by contacting one or more electrolyte precursors in a pre-defined ratio, such as a stoichiometric ratio, to form a precursor mixture and heat treating the precursor mixture to from the sulfide-based solid electrolyte.

Forming the precursor mixture may include milling the electrolyte precursors or pulverizing the electrolyte precursors. Mills such as a ball mill may be used. The milling or pulverization may be performed with or without a solvent. Alternatively, processes such as dissolution using polar or non-polar solvents may be employed.

The precursor mixture may be heat treated in an inert atmosphere to prepare the sulfide-based solid electrolyte. The inert atmosphere may be a vacuum, or an inert gas such as nitrogen or argon. The heat treatment may be performed at a temperature from about 200° C. to about 700° C. for a duration from about 30 minutes to about 36 hours.

For example, the heat treatment may be performed at a temperature from about 200° C. to about 300° C., about 200° C. to about 400° C., about 200° C. to about 500° C., about 200° C. to about 600° C., about 200° C. to about 700° C., about 300° C. to about 400° C., about 300° C. to about 500° C., about 300° C. to about 600° C., about 300° C. to about 700° C., about 400° C. to about 500° C., about 400° C. to about 600° C., about 400° C. to about 700° C., about 500° C. to about 600° C., about 500° C. to about 700° C., or about 600° C. to about 700° C. As another example, the heat treatment may be performed at a temperature of about 200° C., 250° C., 300° C., 400° C., 450° C., 500° C., 550° C., 600° C., 650° C., or about 700° C.

The heat treatment may take place for a duration from about 30 minutes to about 36 hours. As an example, heat treatment may take place for a duration from about 30 minutes to about 1 hour, about 30 minutes to about 2 hours, about 30 minutes to about 4 hours, about 30 minutes to about 8 hours, about 30 minutes to about 12 hours, about 30 minutes to about 24 hours, about 30 minutes to about 36 hours, about 1 hour to about 36 hours, about 2 hours to about 36 hours, about 4 hours to about 36 hours, about 8 hours to about 36 hours, about 12 hours to about 36 hours, or about 24 hours to about 36 hours. As another example, the heat treatment may take place for a duration of about 30 minutes, about 1 hour, about 2 hours, about 3 hours, about 4 hours, about 5 hours, about 6 hours, about 7 hours, about 8 hours, about 9 hours, about 10 hours, about 12 hours, about 15 hours, about 18 hours, about 20 hours, about 24 hours, about 28 hours, about 32 hours, or about 36 hours.

The sulfide-based solid electrolyte may include thiophosphate electrolytes or sulfide-type electrolytes. The sulfide-based solid electrolyte may have the formula Li_{(7-y-z)}PS_{(6-y-z)}X_{y}W_{z}, wherein X and W are individually selected from F, Cl, Br, and I; 0≤y≤2; 0≤z≤2; and wherein 0≤y+z≤2. In a further embodiment, the argyrodite-type electrolyte may have the formula Li⁺_{(12-n-w)} Aⁿ⁺X²⁻_{6-w}Y^{-x}w, wherein Aⁿ⁺ is P, As, Ge, Ga, Sb, Si, Sn, Al, In, Ti, V, Nb, or Ta; X²⁻ is S, Se, or Te; Y⁻ is Cl, Br, I, F, BH₄, BF₄, CN, OCN, SCN, or N₃; wherein 0≤x≤1; 3≤n≤5; and 0≤w≤2. In some embodiments, the sulfide-based solid electrolyte may include Li₃PS₄, Li₄P₂S₆, Li₇P₃S₁₁, Li_{5.5}PS_{4.5}Cl_{1.5}, Li_{5.5}PS_{4.5}ClBr_{0.5}, Li₅PS₄Cl₂, Li₅PS₄ClBr, or any combination thereof.

The electrolyte precursors may include a lithium-containing material, a phosphorus-containing material, a sulfur-containing material, a halogen-containing material, or any combination thereof. The lithium-containing precursor may include Li₂S, Li₂SO₄, LiOH, Li₂CO₃, other lithium-containing precursors known in the art, or any combination thereof. The phosphorus-containing precursor may include P₄S₁₀(P₂S₅), P₄S₉, P₄S₇, P₄Sₓ where X is greater than 10, other phosphorus-containing precursors known in the art, or any combination thereof. The sulfur-containing precursor may include elemental sulfur, Na₂Sₓ, K₂Sₓ, Li₂Sₓ where 1≤X≤8, NaSH, LiSH, AS₂S₅, AS₂S₃, Sb₂S₅, Sb₂S₃, Al₂S₃, SiS₂, GeS₂, SnS₂, PbS₂, B₂S₃, CoS₂, Co₃S₄, CrS, Cr₂S₃, Cr₃S₄, CuS, CuS₂, Cu₂S, FeS, FeS₂, Fe₃S₄, MnS, MnS₂, MoS₂, NiS, NiS₂, Ni₃S₂, ScS, SC₂S₃, SnS₂, TiS, TiS₂, Ti₂S₃, VS, VS₂, V₂S₃, VS₄, Y₂S₃, ZnS, ZrS₂, WS₂, other sulfur-containing precursors known in the art, or any combination thereof. In some embodiments when the sulfur-containing precursor includes Na₂Sₓ, K₂Sₓ, or Li₂Sₓ, X may be 1<X<8; for example, X may be 2, 3, 4, 5, 6, or 7. The halogen-containing precursor may include LiF, LiCl, LiBr, LiI, LiClₓBr_{y} where 0<x<1, 0<y<1, and where x+y=1, other halogen-containing precursors known in the art, or any combination thereof.

Further provided herein are solid-state batteries that include the sulfide-based solid electrolyte described herein. The solid-state battery includes electrochemical cell layers including an anode layer, a separator layer, and a cathode layer. The sulfide-based solid electrolyte may be included in the anode layer, the separator layer, the cathode layer, or any combination thereof.

The solid-state battery may further comprise an oxide, oxysulfide, sulfide, halide, nitride, or any other solid electrolyte known in the art in one or more of the electrochemical cell layers. In some preferred embodiments, the solid electrolyte may comprise a sulfide solid electrolyte material, i.e., a solid electrolyte having at least one sulfur component. In some embodiments, the solid electrolyte may comprise one or more material combinations such as Li₂S—P₂S₅, Li₂S—P₂S₅—LiI, Li₂S—P₂S₅—GeS₂, Li₂S—P₂S₅—Li₂O, Li₂S—P₂S₅—Li₂O—LiI, Li₂S—P₂S₅—LiI—LiBr, Li₂S—SiS₂, Li₂S—SiS₂—LiI, Li₂S—SiS₂—LiBr, Li₂S—S—SiS₂—LiCl, Li₂S—S—SiS₂—B₂S₃—LiI, Li₂S—S—SiS₂—P₂S₅—LiI, Li₂S—B₂S₃, Li₂S—P₂S₅—ZₘSₙ (where m and n are positive numbers, and Z is Ge, Zn or Ga), Li₂S—GeS₂, Li₂S—S—SiS₂—Li₃PO₄, and Li₂S—S—SiS₂-LiₓMO_{y} (where x and y are positive numbers, and M is P, Si, Ge, B, Al, Ga or In). Halide solid electrolytes may have the structure Li-M-X, M is a metal element, and X is a halogen. These can be expressed by the generic formula Li_{α}M⁴⁺_{β}A³⁺_{(1-β)}X_{Ω}Y_{(6-Ω)}, where: 0≤β≤1; 0≤Ω≤6; α=6−[(β*4)+(1−β)*3]; X and Y are each independently a halogen such as F, Cl, Br, I; M is an element with an oxidation state of 4+ such as Ti, Zr, Hf, and Rf; and A is an element an oxidation state of 3+such as Ga, In, and TI, Sc, Y, Fe, Ru, Os, Er. Examples of halide electrolytes include Li₂ZrCl₆, Li₃InCl₆, Li_{2.25}Hf_{0.75}Fe_{0.25}Cl₄Br₂.

In another embodiment, the sulfide-based solid electrolyte may include Li₃PS₄, Li₄P₂S₆, Li₇P₃S₁₁, Li₁₀GeP₂S₁₂, Li₁₀SnP₂S₁₂. In a further embodiment, the solid electrolyte material include Li₆PS₅Cl, Li₆PS₅Br, Li₆PS₅I or expressed by the formula Li_{7-y}PS_{6-y}X_{y} where “X” represents at least one halogen and/or at least one pseudo-halogen, and where 0<y≤2.0 and where the halogen may be one or more of F, Cl, Br, I, and the pseudo-halogen may be one or more of N, NH, NH₂, NO, NO₂, BF₄, BH₄, AlH₄, CN, and SCN. In yet another embodiment, the sulfide-based solid electrolyte be expressed by the formula Li_{8-y-z}P₂S_{9-y-z}X_{y}W_{z} where X and W represents at least one halogen and/or at least one pseudo-halogen and where 0≤y≤1 and 0≤z≤1 and where the halogen may be one or more of F, Cl, Br, I, and the pseudo-halogen may be one or more of N, NH, NH₂, NO, NO₂, BF₄, BH₄, AlH₄, CN, and SCN.

The electrochemical cell layer may include a solid electrolyte in an amount from about 30% to about 99% by weight of the electrochemical cell layer. In some aspects, the solid electrolyte material may be present in the electrochemical cell layer in an amount from about 30% to about 35%, about 30% to about 40%, about 30% to about 45%, about 30% to about 50%, about 30% to about 55%, about 30% to about 60%, about 30% to about 65%, about 30% to about 70%, about 30% to about 75%, about 30% to about 80%, about 30% to about 85%, about 30% to about 90%, about 30% to about 95%, about 35% to about 99%, about 40% to about 99%, about 45% to about 99%, about 50% to about 99%, about 55% to about 99%, about 60% to about 99%, about 65% to about 99%, about 70% to about 99%, about 75% to about 99%, about 80% to about 99%, about 85% to about 99%, about 90% to about 99%, about 40% to about 90%, about 40% to about 80%, about 40% to about 70%, about 40% to about 60%, about 40% to about 55%, about 40% to about 50%, or about 40% to about 45% by weight of the electrochemical cell layer.

When the electrochemical cell layer is a separator layer, the electrochemical cell layer may include a solid electrolyte in an amount from about 60% to about 99% by weight of the separator layer. In some aspects, the solid electrolyte may be present in the electrochemical cell layer in an amount from about 60% to about 65%, about 60% to about 70%, about 60% to about 75%, about 60% to about 80%, about 60% to about 85%, about 60% to about 90%, about 60% to about 95%, about 60% to about 99%, about 65% to about 99%, about 70% to about 99%, about 75% to about 99%, about 80% to about 99%, about 85% to about 99%, about 90% to about 99%, or about 70% to about 90% by weight of the separator layer.

The electrochemical cell layer may comprise a binder where the binder may be one or more of a fluororesin containing vinylidene fluoride (VdF), hexafluoropropylene (HFP), tetrafluoroethylene (TFE), and derivatives thereof as structural units. Specific examples thereof include homopolymers such as polyvinylidene fluoride (PVDF), polyhexafluoropropylene (PHFP), and polytetrafluoroethylene (PTFE), and binary copolymers such as copolymers of VdF and HFP such as poly (vinylene difluoride-hexafluoropropylene) copolymer (PVDF-HFP), and the like. In another embodiment, the binder may include a thermoplastic elastomer such as but not limited to styrene-butadiene rubber (SBR), styrene-butadiene-styrene copolymer (SBS), styrene-isoprene block copolymer (SIS), styrene-ethylene-butylene-styrene (SEBS), polyacrylonitrile (PAN), nitrile-butylene rubber (NBR), polybutadiene, polyisoprene, Poly (methacrylate) nitrile-butadiene rubber (PMMA-NBR) and the like. In a further embodiment, the binder may include an acrylic resin such as but not limited to polymethyl (meth) acrylate, polyethyl (meth) acrylate, polyisopropyl (meth) acrylate polyisobutyl (meth) acrylate, polybutyl (meth) acrylate, and the like. In yet another embodiment, the binder may include a polycondensation polymer such as but not limited to polyurea, polyamide paper, polyimide, polyester, and the like. In yet a further embodiment, the binder may include a nitrile rubber such as but not limited to acrylonitrile-butadiene rubber (ABR), polystyrene nitrile-butadiene rubber (PS-NBR), and mixtures thereof.

Preferably, the binder comprises a thermoplastic elastomer such as those comprising styrene and butadiene. For example, the binder may comprise styrene-butadiene-styrene copolymer (SBS), styrene-isoprene block copolymer (SIS), styrene-ethylene-butylene-styrene (SEBS), or combinations thereof.

The binder may be present in the electrochemical cell layer in an amount from about 1% to about 30% by weight of the electrochemical cell layer. For example, the binder may be present in the electrochemical cell layer in an amount from about 1% to about 5%, about 1% to about 10%, about 1% to about 15%, about 1% to about 20%, about 1% to about 25%, about 1% to about 30%, about 5% to about 30%, about 10% to about 30%, about 15% to about 30%, about 20% to about 30%, about 25% to about 30%, about 5% to about 15%, about 5% to about 20%, about 10% to about 15%, about 10% to about 20%, or about 15% to about 20% by weight of the electrochemical cell layer.

The electrochemical cell layer may further comprise a conductive additive where the conductive additive may include metal powders, fibers, filaments, or any other material known to conduct electrons. The conductive additive may comprise a carbon-based conductive additive, such as carbon fiber, graphite, graphene, carbon black, conductive carbon, amorphous carbon, vapor grown carbon fiber (VGCF), carbon nanotubes, carbon nanowires, activated carbon, and combinations thereof.

The conductive additive may be present in the electrochemical cell layer in an amount from about 0% to about 15% by weight of the electrochemical cell layer. In some aspects, the conductive additive may be present in the electrochemical cell layer in an amount from about 0% to about 10%, or about 0% to about 5% by weight of the electrochemical cell layer. In some additional aspects, the conductive additive may be present in the electrochemical cell layer in an amount of about 0%, 1%, 2%, 3%, 4%, 5%, 6%, 7%, 8%, 9%, 10%, 11%, 12%, 13%, 14%, or about 15% by weight of the electrochemical cell layer. In an example embodiment, the conductive additive is present in the electrochemical cell layer in an amount from about 0% to about 5% by weight of the electrochemical cell layer.

In some embodiments, the average particle size of the conductive additive may be from about 5 nm to about 1000 nm. In some aspects, the average particle size of the conductive additive may be about from 5 nm to about 100 nm, about 5 nm to about 200 nm, about 5 nm to about 300 nm, about 5 nm to about 400 nm, about 5 nm to about 500 nm, about 5 nm to about 600 nm, about 5 nm to about 700 nm, about 5 nm to about 800 nm, about 5 nm to about 900 nm, about 100 nm to about 1000 nm, about 200 nm to about 1000 nm, about 300 nm to about 1000 nm, about 400 nm to about 1000 nm, about 500 nm to about 1000 nm, about 600 nm to about 1000 nm, about 700 nm to about 1000 nm, about 800 nm to about 1000 nm, about 900 nm to about 1000 nm, about 100 nm to about 500 nm, or about 200 nm to about 400 nm. In some embodiments, the conductive additive may have a particle size of about 5 nm, 10 nm, 20 nm, 30 nm, 40 nm, 50 nm, 60 nm, 70 nm, 80 nm, 90 nm, 100 nm, 200 nm, 300 nm, 400 nm, 500 nm, 600 nm, 700 nm, 800 nm, 900 nm, or about 1000 nm. In some examples, the conductive additive may have an average particle size of about 30 nm. The average particle size (e.g., D50) may be determined through any method known to those having ordinary skill in the art, for example, by a particle size analyzer or a transmission electron microscope photograph or a scanning electron microscope photograph. Alternatively, the size may be measured using a dynamic light scattering method, and data analysis may be performed to count the number of particles with respect to each particle size range, and then calculated therefrom to obtain an average particle diameter value. Unless otherwise specified, the average particle diameter may be measured by a particle size analyzer, and refers to a diameter (D50) of particles having a cumulative volume of 50 vol % in a particle size distribution.

In some embodiments, the electrochemical cell layer may comprise an anode active material. The anode active material preferably is an inorganic material. The anode active material may comprise one or more inorganic materials such as silicon (Si), silicon alloys, tin (Sn), tin alloys, germanium (Ge), germanium alloys, graphite, Li₄Ti₅O₁₂ (LTO) or other known anode active materials and combinations thereof.

The anode active material may be present in the electrochemical cell layer in an amount from about 30% to about 98% by weight of the electrochemical cell layer. In some aspects, the anode active material may be present in the electrochemical cell layer in an amount of about 30% to about 35%, about 30% to about 40%, about 30% to about 45%, about 30% to about 50%, about 30% to about 55%, about 30% to about 60%, about 30% to about 65%, about 30% to about 70%, about 30% to about 75%, about 30% to about 80%, about 30% to about 85%, about 30% to about 90%, about 30% to about 95%, about 35% to about 98%, about 40% to about 98%, about 45% to about 98%, about 50% to about 98%, about 55% to about 98%, about 60% to about 98%, about 65% to about 98%, about 70% to about 98%, about 75% to about 98%, about 80% to about 98%, about 85% to about 98%, about 90% to about 98%, about 40% to about 90%, about 40% to about 80%, about 40% to about 70%, about 40% to about 60%, about 40% to about 55%, about 40% to about 50%, or about 40% to about 45% by weight of the electrochemical cell layer.

In some embodiments, the electrochemical cell layer may comprise a cathode active material. The cathode active material may include nickel-manganese-cobalt (“NMC”) which can be expressed as Li(NiₐCo_{b}Mn_{c})O₂ (0<a<1, 0<b<1, 0<c<1, a+b+c=1) or, for example, NMC 111 (LiNi_{0.33}Mn_{0.33}Co_{0.33}O₂), NMC 433 (LiNi_{0.4}Mn_{0.3}Co_{0.3}O₂), NMC 532 (LiNi_{0.5}Mn_{0.3}Co_{0.2}O₂), NMC 622 (LiNi_{0.6}Mn_{0.2}Co_{0.2}O₂), NMC 811 (LiNi_{0.8}Mn_{0.1}Co_{0.1}O₂) or a combination thereof. In another embodiment, the cathode active material may include a coated or uncoated metal oxide, such as but not limited to V₂O₅, V₆O₁₃, MoO₃, LiCoO₂, LiNiO₂, LiMnO₂, LiMn₂O₄, LiNi_{1-Y}Co_{Y}O₂, LiCo_{1-Y}Mn_{Y}O₂, LiNi_{1-Y}Mn_{Y}O₂ (0≤Y<1), Li(NiₐCo_{b}Mn_{c})O₄ (0<a<2, 0<b<2, 0<c<2, a+b+c=2), LiMn_{2-Z}Ni_{Z}O₄, LiMn_{2-Z}Co_{Z}O₄ (0<Z<2), LiCoPO₄, LiFePO₄, CuO, Li(NiₐCo_{b}Al_{c})O₂ (0<a<1, 0<b<1, 0<c<1, a+b+c=1) or a combination thereof. In yet another embodiment, the cathode active material may include a coated or uncoated metal sulfide such as but not limited to titanium sulfide (TiS₂), molybdenum sulfide (MoS₂), iron sulfide (FeS, FeS₂), copper sulfide (CuS), and nickel sulfide (Ni₃S₂) or combinations thereof. In still further embodiments, the cathode active material may comprise elemental sulfur(S). In additional embodiments, the cathode active material may include a fluoride cathode active material such as but not limited to lithium fluoride (LiF), sodium fluoride (NaF), calcium fluoride (CaF₂), magnesium fluoride (MgF₂), nickel (II) fluoride (NiF₂), iron (III) fluoride (FeF₃), vanadium (III) fluoride (VF₃), cobalt (III) fluoride (CoF₃), chromium (III) fluoride (CrF₃), manganese (III) fluoride (MnF₃), aluminum fluoride (AlF₃), and zirconium (IV) fluoride (ZrF₄), or combinations thereof.

The cathode active material may be present in the electrochemical cell layer in an amount from about 30% to about 98% by weight of the electrochemical cell layer. In some aspects, the cathode active material may be present in the electrochemical cell layer in an amount of about 30% to about 35%, about 30% to about 40%, about 30% to about 45%, about 30% to about 50%, about 30% to about 55%, about 30% to about 60%, about 30% to about 65%, about 30% to about 70%, about 30% to about 75%, about 30% to about 80%, about 30% to about 85%, about 30% to about 90%, about 30% to about 95%, about 35% to about 98%, about 40% to about 98%, about 45% to about 98%, about 50% to about 98%, about 55% to about 98%, about 60% to about 98%, about 65% to about 98%, about 70% to about 98%, about 75% to about 98%, about 80% to about 98%, about 85% to about 98%, about 90% to about 98%, about 40% to about 90%, about 40% to about 80%, about 40% to about 70%, about 40% to about 60%, about 40% to about 55%, about 40% to about 50%, or about 40% to about 45% by weight of the electrochemical cell layer.

### EXAMPLES

### Example 1: Forming Pristine Electrolyte Material

Li₂S, P₂S₅ and LiCl were combined in a 5:1:2 mol ratio to produce a sulfide-based solid electrolyte material having an Argyrodite structure. The mixture was milled in a solvent, dried, and crystallized to form an electrolyte material which has a D50 particle size distribution (PSD) of 1.3 μm and a surface area of 9.4 m²/g.

### Example 2: Processing without Sulfur (Comparative Example)

An aliquot of the material produced in Example 1 was placed in a glass beaker and heated to 450° C. for 30 minutes. This heat treatment resulted in an electrolyte material having a PSD with a D50 of 13.4 μm and a surface area of 10.8 m²/g.

### Example 3: Processing with Sulfur-Open Container

An aliquot of the material produced in Example 1 was mixed with elemental sulfur forming a mixture including 90% electrolyte by volume and 10% sulfur by volume. The composite was placed in a glass beaker and heated to 450° C. for 30 minutes. The heat treatment with sulfur resulted in an electrolyte material having PSD with a D50 of 30.6 μm and a surface area of 3.2 m²/g.

### Example 4: Process with Sulfur-Semi-Sealed Container

An aliquot of the material produced in Example 1 was mixed with elemental sulfur forming a mixture including 90% electrolyte by volume and 10% sulfur by volume. The composite was placed in a semi-sealed ampule and heated to 450° C. for 30 minutes. The heat treatment with sulfur in the semi-sealed container resulted in an electrolyte material having PSD with a D50 of 55.9 μm and a surface area of 1.5 m²/g.

### Analysis

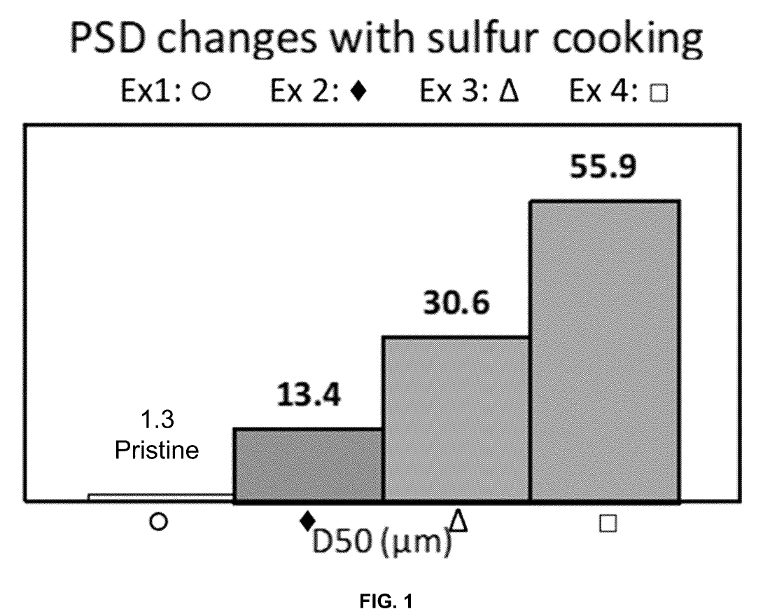

From FIG. 1, it can be seen that by contacting an electrolyte material with sulfur in a molten state, the particle size of the electrolyte material was increased from 1.3 μm to 30.6 μm when using an open container. When using a semi-sealed container, the particle size of the electrolyte material was increased from 1.3 μm to 55.9 μm.

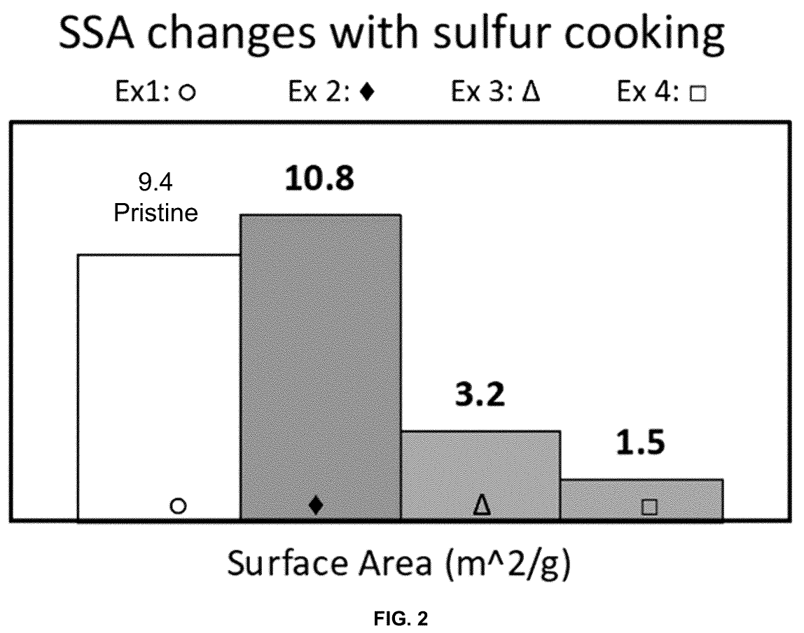

From FIG. 2, it can be seen that by contacting an electrolyte material with molten sulfur, the specific surface area of the electrolyte material decreased from 9.4 m²/g to 3.2 m²/g when using an open container. When using a semi-sealed container, the specific surface area of the electrolyte material decreased from 9.4 m²/g to 1.5 m²/g.

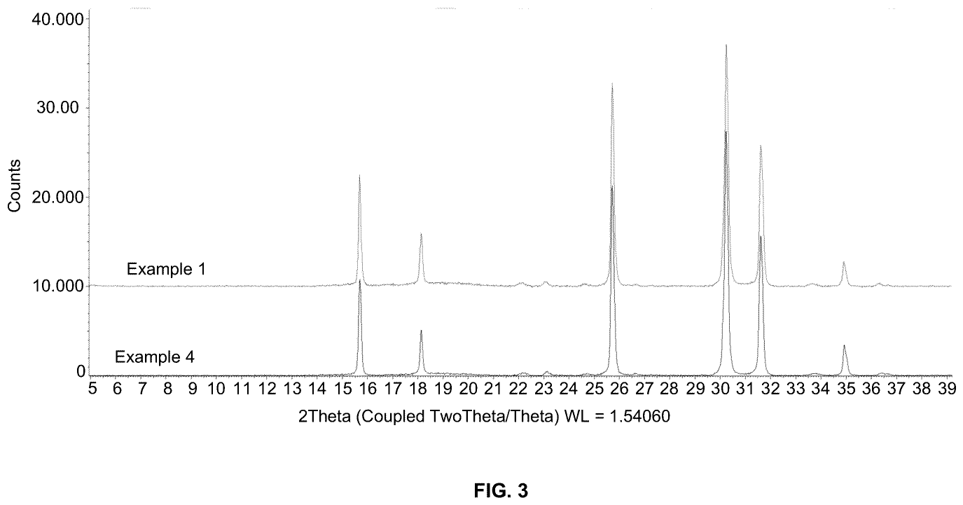

FIG. 3 shows X-ray diffraction patterns for the solid electrolytes produced in Examples 1 and 4.

What is claimed is:

1. A process for growing the particle size of a solid electrolyte including lithium and sulfur, the process comprising:
combining the solid electrolyte with molten elemental sulfur at a temperature greater than 100° C. for a period of time greater than 1 minute; and
separating the solid electrolyte from the molten elemental sulfur.

2. The process of claim 1, where at least 90% of the molten elemental sulfur is separated from the solid electrolyte by way of filtering, centrifuging, evaporating or combination thereof.

3. The process of claim 1, wherein combining the solid electrolyte with the molten elemental sulfur takes place at a temperature from about 115° C. to about 500° C.

4. The process of claim 1, wherein combining the solid electrolyte with the molten elemental sulfur takes place for a period of time from about 15 minutes to about 36 hours.

5. The process of claim 1, wherein the weight ratio between the molten elemental sulfur and the solid electrolyte is from about 1:99 to about 99:1.

6. The process of claim 1, wherein the weight ratio between the molten elemental sulfur and the solid electrolyte is from about 1:9 to about 9:1.

7. The process of claim 1, wherein the combining occurs in an open vessel.

8. The process of claim 1, wherein the combining occurs in a semi-closed vessel.

9. The process of claim 1, wherein the average particle size of the solid electrolyte increases by greater than 10% as a result of the combining.

10. The process of claim 1, wherein the average particle size of the solid electrolyte decreases by greater than 10% as a result of the combining.

11. A solid electrolyte produced by the process of claim 1.

12. The solid electrolyte of claim 11, wherein the solid electrolyte has a particle size distribution (PSD) with a D50 of greater than about 30 μm.

13. The solid electrolyte of claim 11, wherein the solid electrolyte has a specific surface area from about 0.1 m²/g to about 5 m²/g.

14. The solid electrolyte of claim 11, wherein the solid electrolyte has an amorphous structure.

15. The solid electrolyte of claim 11, wherein the solid electrolyte has a crystalline structure.

16. The solid electrolyte of claim 11, wherein the solid electrolyte has an Argyrodite structure.

17. The solid electrolyte of claim 11, wherein the solid electrolyte has an X-ray diffraction pattern with peaks corresponding to a 2theta of 17.5°±0.5°, 18.1°±0.5°, 19.9°±0.5°, 22.8°±0.5°, 25.95°±0.5°, 29.1°±0.5°, 29.9°±0.5°, and 31.1°±0.5° with Cu-Kα(1,2)=1.541 Å.

18. The solid electrolyte of claim 11, wherein the solid electrolyte has the formula Li_{(7-y-z)}PS_{(6-y-z)}X_{y}W_{z}, wherein X and W are individually selected from F, Cl, Br, and I; 0≤y≤2; 0≤z≤2; and wherein 0≤y+z≤2.

19. The solid electrolyte of claim 11, wherein the solid electrolyte includes Li₃PS₄, Li₄P₂S₆, Li₇P₃S₁₁, Li_{5.5}PS_{4.5}Cl_{1.5}, Li_{5.5}PS_{4.5}ClBr_{0.5}, Li₅PS₄Cl₂, Li₅PS₄ClBr, or any combination thereof.

20. A solid electrolyte comprising lithium and sulfur having a particle size with a D50 greater than 50 μm produced by:
combining the solid electrolyte with molten elemental sulfur at a temperature greater than 100° C. and for a period of time greater than 1 minute; and
separating the solid electrolyte from the molten elemental sulfur.

21. The electrolyte material of claim 20, comprising an amorphous structure, a crystalline structure, or combination thereof.

22. The electrolyte material of claim 21, having an Argyrodite structure.

23. A solid-state battery comprising:
an anode layer;
a separator layer; and
a cathode layer, wherein one or more of the anode layer, the separator layer, and the cathode layer includes a solid electrolyte of claim 1.

24. The solid-state battery of claim 23, wherein the solid electrolyte has a specific surface area from about 0.1 m²/g to about 5 m²/g.
